(19) United States
(12) Patent Application Publication
(10) Pub. No.: US 2024/0231874 A1
(43) Pub. Date: Jul. 11, 2024

(54) PER SERVICE VERSION ROLL BACK IN DISTRIBUTED COMPUTING SYSTEMS

(71) Applicant: VMWARE, INC., Palo Alto, CA (US)

(72) Inventors: Pankaj RODGE, Pune (IN); Prashant SHELKE, Pune (IN); Mitesh SHARMA, Pune (IN); Antion K. SHIBAN, Pune (IN); Vasantha Kumar DHANASEKAR, Chennai (IN)

(21) Appl. No.: 18/120,452

(22) Filed: Mar. 13, 2023

(30) Foreign Application Priority Data
Jan. 9, 2023 (IN) 202341001801

(51) Int. Cl. G06F 9/455

(52) U.S. Cl. CPC G06F 9/45558; G06F 2009/4557; G06F 2009/45587; G06F 2009/45591

(57) ABSTRACT

In an example, a management node includes a version rollback module to receive a request to upgrade a distributed computing system. Further, the version rollback module may upgrade the distributed computing system including a first service and a second service to a second version while retaining the first version of the first service and the second service. Upon upgrading the distributed computing system, the version rollback module may detect an issue associated with the second version of the first service. Upon detecting the issue, the version rollback module may perform a rollback operation to roll back the first service to the first version while retaining second version of the second service.

### RELATED APPLICATIONS

Benefit is claimed under 35 U.S.C. 119(a)-(d) to Foreign Application Serial No. 202341001801 filed in India entitled “PER SERVICE VERSION ROLL BACK IN DISTRIBUTED COMPUTING SYSTEMS”, on Jan. 09, 2023, by VMware, Inc., which is herein incorporated in its entirety by reference for all purposes.

### TECHNICAL FIELD

The present disclosure relates to computing environments, and more particularly to methods, techniques, and systems to perform per service version rollback operation in distributed computing systems.

### BACKGROUND

Virtual computing instances (VCIs), such as virtual machines, virtual workloads, data compute nodes, clusters, and containers, among others, have been introduced to lower data center capital investment in facilities and operational expenses and reduce energy consumption. A VCI is a software implementation of a computer that executes application software analogously to a physical computer. A distributed computing system can include multiple virtual components running on multiple VCIs, which can be associated with a plurality of data centers. Further, such a distributed computing system may be upgraded to include new features, performance enhancement, and the like.

### BRIEF DESCRIPTION OF THE DRAWINGS

FIG. 1 is a block diagram of an example system, depicting a management node to perform version roll back of individual services in a distributed computing system;

FIG. 2 is a flow diagram illustrating an example computer-implemented method for performing a rollback operation to roll back a first service to a first version while retaining a second version of remaining services in a distributed computing system;

FIG. 3A is a block diagram of an example distributed computing system operating on multiple distributed compute nodes connected over the Internet;

FIG. 3B is a block diagram of the example distributed computing system of FIG. 3A, depicting upgraded services of the distributed computing system;

FIG. 3C is a block diagram of the example distributed computing system of FIG. 3B, depicting per service version roll back;

FIG. 4 is a user interface of a management plane, depicting a user-selectable option to roll back a service;

FIG. 5A is an example user interface of a management plane, depicting an example message indicating that a virtual private network (VPN) service is rolled back to a first version;

FIG. 5B is another example user interface of the management plane, depicting an example message indicating an unavailability of a new feature of an upgraded version; and

FIG. 6 is a block diagram of an example management node including non-transitory computer-readable storage medium storing instructions to perform version roll back of individual services in a distributed computing system.

The drawings described herein are for illustrative purposes and are not intended to limit the scope of the present subject matter in any way.

### DETAILED DESCRIPTION

Examples described herein may provide an enhanced computer-based and/or network-based method, technique, and system to perform per service version roll back in distributed computing systems. The paragraphs [0014] to [0021] present an overview of the distributed computing systems, existing methods to upgrade the distributed computing systems, and drawbacks associated with the existing methods.

A distributed computing system (also referred to as a distributed software system) may refer to a construct which involves various infrastructure parties that act together to enable a business service. For example, the distributed computing system includes components that are located on different networked computers, which communicate and coordinate their actions by passing messages to one another. In some examples, multiple virtual computing instances (VCIs) can be configured to be in communication with each other in the distributed computing system (e.g., a software defined data network). The term “VCI” covers a range of computing functionality. For example, VCIs may include virtual machines (VMs), and/or containers. Containers can run on a host operating system without a hypervisor or separate operating system, such as a container that runs within Linux. A container can be provided by a virtual machine that includes a container virtualization layer (e.g., Docker). The virtual machine refers to an isolated user space instance, which can be executed within a virtualized environment. Other technologies aside from hardware virtualization can provide isolated user space instances, also referred to as VCIs. The term “VCI” covers these examples and combinations of different types of VCIs, among others.

The virtual machines operate with their own guest operating systems on a host using resources of the host virtualized by virtualization software (e.g., a hypervisor, virtual machine monitor, and the like.). The tenant (i.e., the owner of the virtual machine) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers.

In such examples, the distributed computing system may include multiple services (e.g., cloud-based services) running on respective isolated virtual computing instances in a network virtualization platform. The network virtualization platform may include a management plane, a data plane, and/or a control plane. The data plane refers to functions and processes that forward packets/frames from one interface to another. The control plane refers to functions and processes that determine which path to use (such as LDP, Routing protocols, etc.). The management plane refers to functions used to control and monitor devices via a graphical user interface.

In some examples, the management plane may be built by a network virtualization and security platform that enables a virtual cloud network, a software-defined approach to networking that extends across data centers, clouds, and application frameworks. An example network virtualization and security platform may include NSX-T™, a software-defined networking and security product offered by VMware®. The data plane may include an NSX® Virtual Switch™, which is based on a vSphere distributed switch (VDS) with additional components to enable services. The NSX® Virtual Switch™ refers to software that operates in server hypervisors to form a software abstraction layer between servers and the physical network. The VDS provides a centralized interface to configure, monitor, and administer virtual machine access switching for the entire data center. Further, the control plane may run in a NSX controller cluster. An NSX controller is an advanced distributed state management system that provides control plane functions for logical switching and routing functions. The control plane is the central control point for all logical switches within a network and maintains information about all hosts, logical switches (VXLANs), and distributed logical routers.

For example, the NSX may be developed as a scale out architecture including components such as a management plane cluster (MP), a control plane cluster (CCP), an Edge and a data plane cluster (DP). The DP may include hypervisor nodes of different virtualization technologies such as an enterprise-class, type-1 hypervisor (ESX), a Kernel-based virtual machine (KVM), and the like. The CCP may include a cluster of controller nodes responsible for configuring networking flows in the hypervisors. The MP may be a cluster of management nodes which provides a management interface to an end user. Thus, the NSX works by implementing three separate but integrated planes, i.e., management, control, and data planes. The three planes may be implemented as a set of processes, modules, and agents residing on three types of nodes such as a NSX manager, a controller, Edges, and a transport node.

Further, to stay and remain competitive in the market, such distributed computing systems may be upgraded to include new features, government compliances, reporting, analytics, and the like. For example, the distributed computing systems upgradation may not be limited to increase in productivity, improved communication, improved efficiency, better security, enhancements, extra support, reduced cost, compatibility, reduce outages, better customer engagements, and business growth.

In some examples, the distributed computing system may be upgraded using an upgrade coordinator, which is a module responsible for upgrading all the components in an automated and ordered manner with an upgrade order (e.g., Edge ->DP ->CCP and MP), for instance. The NSX provides numerous services such as a virtual private network (VPN), a load balancer (L3/L2), a domain name system (DNS), a dynamic host configuration protocol (DHCP), a transport layer security (TLS) decryption, an intrusion detection and prevention system (IDPS), an anti-malware, and the like. Further, the data path of these services may be provided through the NSX Edge, and the management of these services may be provided by the NSX manager. Furthermore, users of the distributed computing system can use the NSX manager's representational state transfer application programming interfaces (REST APIs) to configure these services on the Edge.

When all the NSX components (e.g., Edges, hosts, NSX manager, and the like) get upgraded successfully, then the distributed computing system may be declared as being upgraded from version 1 (V1) to version 2 (V2). However, post upgrade of the distributed computing system, consider that an issue is detected in the management plane for one of the services (e.g., the VPN), where a user is not able to perform configure, modify, or delete operations in the data center. In this case, the user's production environment may be impacted. In some existing methods, the user may be required to report the issue and till then the user is blocked. In some other existing methods, the user may have to wait for a hot patch to fix the issue, which can take a significant amount of time. In some other existing methods, the user may have to wait for a next release, which can again take a significant amount of time (e.g., a quarter or a half year time frame). Moreover, the release (version V2) may have to be pulled off from the public site to refrain users from downloading the upgrade bits so that other users may not experience the same issue.

Examples described herein may provide a management node to perform per service version rollback operations in distributed computing systems. An example distributed computing system may include a first service executed by a first isolated virtual computing instance and a second service executed by a second isolated virtual computing instance. For example, the first service can be implemented as part of a management plane and the second service can be implemented as part of a data plane or a control plane. In an example, the management node may receive a request to upgrade the distributed computing system. Further, the management node may upgrade the distributed computing system including the first service and the second service to a second version while retaining the first version of the first service and the second service. Upon upgrading the distributed computing system, the management node may detect an issue associated with the second version of the first service. In this example, the management node may perform a rollback operation to roll back the first service to the first version while retaining second version of the second service.

Thus, examples described herein may enable version roll back of the first service running in the management plane from the second version to the first version while retaining the second version of remaining services of the distributed computing system running in the management plane, control plane, and/or data plane. By facilitating the roll back of individual services of the distributed computing system, the customer's production environment may not get impacted. Further, examples described herein may enable the data path (e.g., services of the data plane) to continue to work, without any downtime. Furthermore, examples described herein may avoid roll back of the entire distributed computing system (which may be significantly costly and consume significant amount of time), and also avoid pulling off the release from the public site. In this case, users can still download the upgrade package with known exceptions. With the examples described herein, any issue in one service may not impact operations of remaining services in the distributed computing system. In this example, upon performing the version roll back of the service having the issue, users can use new features of the remaining services with upgraded versions.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

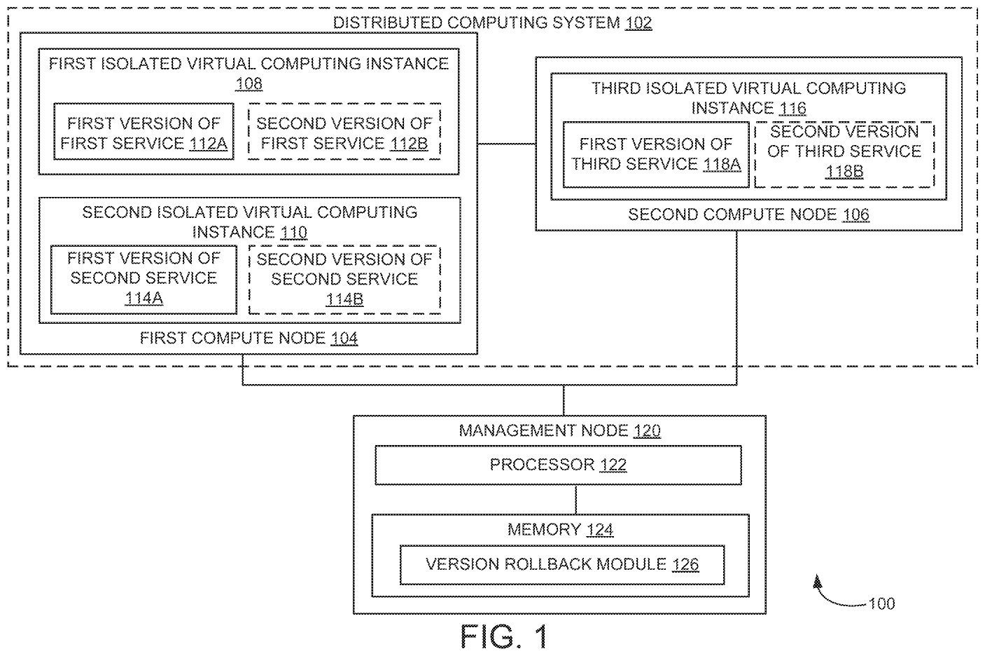

FIG. 1 is a block diagram of an example system 100, depicting a management node 120 to perform version roll back of individual services in a distributed computing system 102. In an example, system 100 may depict a computing environment, which may be a networked computing environment such as an enterprise computing environment, a cloud computing environment, a virtualized environment, a cross-cloud computing environment, or the like. An example cloud computing environment may be VMware vSphere®, which is VMware's virtualization platform. As shown in FIG. 1, system 100 includes distributed software system 102, which may refer to a construct which involves various infrastructure parties that act together to enable a business service.

Example distributed computing system 102 includes multiple services (e.g., a first service, a second service, and a third service) running on respective isolated virtual computing instances (e.g., a first isolated virtual computing instance 108, a second isolated virtual computing instance 110, and a third isolated virtual computing instance 116) in a network virtualization platform. The network virtualization platform may include a management plane and at least one of a data plane and a control plane. The terms “management plane”, “data plane”, and “control plane” refer to functional descriptions of elements of distributed computing system 102 that perform specialized functions. The management plane may be responsible to define intent of the user to add, edit, and delete any configuration, functionality. The management plane may provide an interface to an end user to process user queries, process user configurations, and operational tasks for data and control planes. In other examples, the management plane may be configured to, for example, perform tasks related to input validation, user management, policy management, and background task tracking. In some examples, the management plane provides a single application programming interface (API) entry point to distributed computing system 102.

The data plane is coupled with the management plane. The data plane may physically handle the intent/task/operations supplied or provided by the management plane. For example, the data plane is configured to index data during data ingestion and store the indexed data. In some examples, the data plane is configured to ingest data received from the management plane and query the stored data. The data plane may include a collection of data plane containers.

In some examples, the data plane is responsible for handling the data packets and applying actions to them, based on rules that are programmed into lookup tables. Furthermore, the control plane may be tasked with calculating and programming actions for the data plane. In some examples, the control plane is also responsible to distribute the same data across all the data plane components.

As shown in FIG. 1, distributed computing system 100 includes multiple compute nodes such as a first compute node 104 (e.g., that can be implemented as part of the management plane) and a second compute node 106 (e.g., that can be implemented as part of the data plane or the control plane) communicating with first compute node 104 via a network. Example compute nodes 104 and 106 may include, but not limited to, physical host computing devices, virtual machines, or the like. The virtual machines, in some examples, may operate with their own guest operating systems on a physical host computing device using resources of the physical host computing device virtualized by virtualization software (e.g., a hypervisor, a virtual machine monitor, and the like). A container is a data computer node that runs on top of a host operating system without the need for a hypervisor or separate operating system.

As shown in FIG. 1, first compute node 104 includes first isolated virtual computing instance 108 executing a first version of a first service 112A of distributed computing system 102. Further, first compute node 104 includes second isolated virtual computing instance 110 executing a first version of a second service 114A of distributed computing system 102. An example isolated virtual computing instance may include, but not limited to, a container, a pod, a virtual machine, a namespace, a separate jar file per service, or the like. In some examples, the first compute node 104's operating system uses name spaces to isolate the containers (i.e., isolated virtual computing instances) from each other and therefore provides operating-system level segregation of the different groups of applications/services that operate within different containers. The processes of a container are isolated from processes executing outside of the container namespace. Furthermore, second compute node 106 includes third isolated virtual computing instance 116 executing a first version of third service 118A of distributed computing system 102. In an example, first isolated virtual computing instance 108 and second isolated virtual computing instance 110 can be implemented as part of the management plane and third isolated virtual computing instance 116 can be implemented as part of the data plane or the control plane.

For example, the network can be a managed Internet protocol (IP) network administered by a service provider. The example network may be implemented using wireless protocols and technologies, such as Wi-Fi, WiMAX, and the like. In other examples, the network can also be a packet-switched network such as a local area network, wide area network, metropolitan area network, Internet network, or other similar type of network environment. In yet other examples, the network may be a fixed wireless network, a wireless local area network (LAN), a wireless wide area network (WAN), a personal area network (PAN), a virtual private network (VPN), intranet or other suitable network system and includes equipment for receiving and transmitting signals.

Further, distributed computing system 102 may be communicatively connected to management node 120. Management node 120 may refer to a computing device or computer program (i.e., executing on a computing device) that provides service to first compute node 104 and second compute node 106. Further, management node 120 includes a processor 122 and a memory 124 coupled to processor 122. Processor 122 may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. Processor 122 may for example, include single or multiple cores on a chip, multiple cores across multiple chips, multiple cores across multiple devices, or suitable combinations thereof. Processor 122 may be functional to fetch, decode, and execute instructions as described herein. Example memory 124 includes a version rollback module 126.

During operation, version rollback module 126 may receive a request to upgrade distributed computing system 102. Further, version rollback module 126 may upgrade distributed computing system 102 including first service 112A and second service 114A to a second version (i.e., a second version of first service 112B and a second version of second service 114B) while retaining the first version of first service 112A and second service 114A.

Upon upgrading distributed computing system 102, version rollback module 126 may detect an issue associated with the second version of first service 112B. Further, version rollback module 126 may perform a rollback operation to roll back first service 112A to the first version while retaining the second version of second service 114B.

In an example, during the upgrade of distributed computing system 102, version rollback module 126 may detect an error or failure associated with the upgrade of first service 112A. In response to detecting the error or failure associated with the upgrade of first service 112A, version rollback module 126 may perform the rollback operation to roll back first service to the first version (e.g., 112A) while retaining the second version of second service 114B (i.e., remaining services of the management plane).

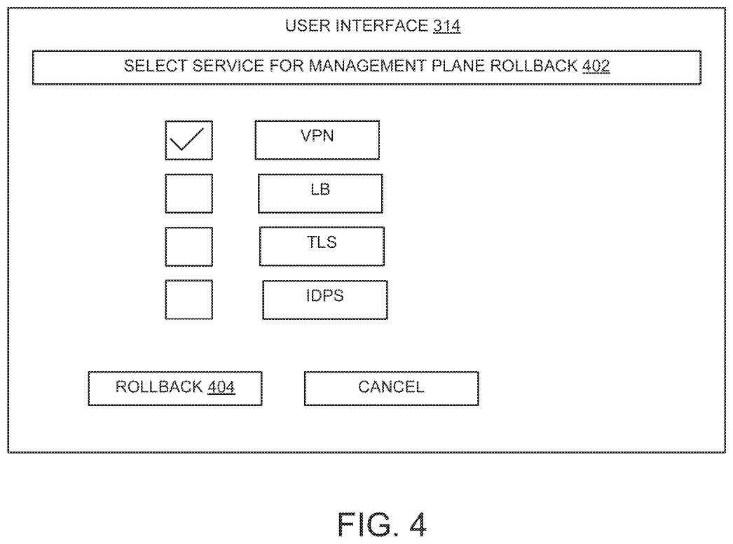

In another example, upon completing the upgrade of distributed computing system 102, version rollback module 126 may provide a user-selectable option to roll back the first service in the user interface of the management plane. Upon a user selection of the user-selectable option, version rollback module 126 may perform the rollback operation to roll back the first service from the second version (i.e., 112B) to the first version (i.e., 112A) while retaining the second version of the second service (i.e., 114B). In yet another example, upon completing the upgrade of distributed computing system 102, version rollback module 126 may provide a user-selectable option in a user interface of the management plane to enable a user to navigate through a roll back process of first service 112A. An example of such user interface is depicted in FIG. 4.

In an example, upon rolling back the first service to the first version (i.e., 112A) and when the second version (i.e., 112B) does not include a new feature, version rollback module 126 may display a notification on a user interface of the first service indicating that the first service is rolled back to the first version. In another example, upon rolling back the first service to the first version (i.e., 112A) and when the second version (i.e., 112B) includes a new feature, version rollback module 126 may display a notification on a user interface of the first service indicating an unavailability of the new feature.

In some examples, version rollback module 126 may determine a dependent service of distributed computing system 102 that is having a dependency relationship with the second version of the first service (i.e., 112B). Further, version rollback module 126 may determine a functionality of the dependent service that is likely to affect. Furthermore, version rollback module 126 may generate a notification on the user interface to indicate the functionality of the dependent service that is likely to affect.

As shown in FIG. 1, second compute node 106 may include third isolated virtual computing instance 116 executing a first version of a third service 118A of distributed computing system 102. During operation, version rollback module 126 may upgrade distributed computing system 102 including first service 112A, second service 114A, and third service 118A to a corresponding second version (e.g., second version of first service 112B, second version of second service 114B, and second version of third service 118B). In this example, version rollback module 126 may perform a rollback operation to roll back first service 112A to the first version while retaining the second version of second service 114B (i.e., running in the management plane) and second version of third service 118B (i.e., running in the data plane, control plane, or both).

In some examples, the functionalities described in FIG. 1, in relation to instructions to implement functions of version rollback module 126 and any additional instructions described herein in relation to the storage medium, may be implemented as engines or modules including any combination of hardware and programming to implement the functionalities of the modules or engines described herein. The functions of version rollback module 126 may also be implemented by a processor. In examples described herein, the processor may include, for example, one processor or multiple processors included in a single device or distributed across multiple devices.

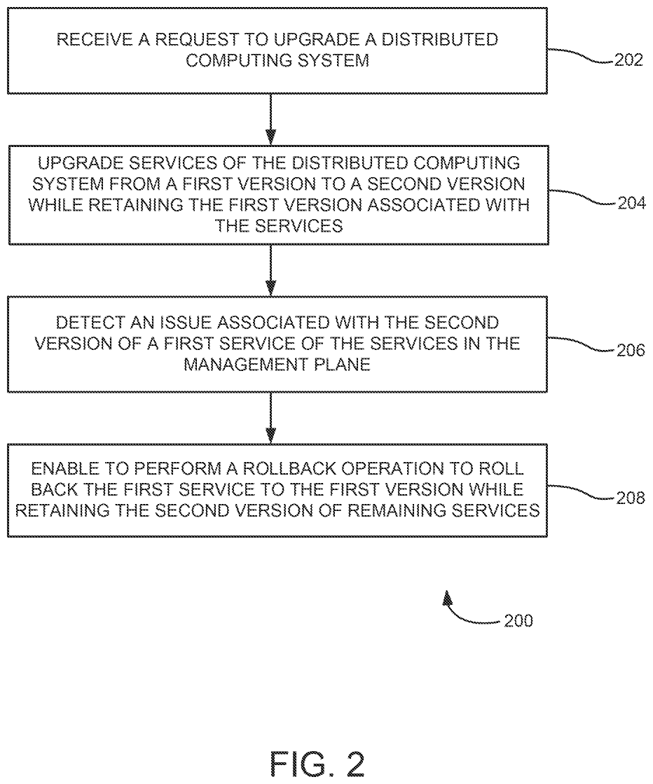

FIG. 2 is a flow diagram illustrating an example computer-implemented method 200 for performing a rollback operation to roll back a first service to a first version while retaining a second version of remaining services in a distributed computing system. Example method 200 may represent generalized illustrations, and other processes may be added, or existing processes may be removed, modified, or rearranged without departing from the scope and spirit of the present application. In addition, method 200 may represent instructions stored on a computer-readable storage medium that, when executed, may cause a processor to respond, to perform actions, to change states, and/or to make decisions. Alternatively, method 200 may represent functions and/or actions performed by functionally equivalent circuits like analog circuits, digital signal processing circuits, application specific integrated circuits (ASICs), or other hardware components associated with the system. Furthermore, the flow chart is not intended to limit the implementation of the present application, but the flow chart illustrates functional information to design/fabricate circuits, generate computer-readable instructions, or use a combination of hardware and computer-readable instructions to perform the illustrated processes.

At 202, a request to upgrade a distributed computing system may be received. In an example, the distributed computing system may include multiple services running on respective isolated virtual computing instances in a network virtualization platform. An example network virtualization platform may include a management plane and at least one of a data plane and a control plane. In an example, a first service may include a first component running in the management plane and a second component running in the data plane and/or the control plane.

At 204, the services of the distributed computing system may be upgraded from a first version to a second version while retaining the first version associated with the services. At 206, upon upgrading the distributed computing system, an issue associated with the second version of a first service of the services may be detected in the management plane. In an example, detecting the issue associated with the second version of the first service may include detecting an error or failure associated with the upgrade of the first service during the upgrading of the services of the distributed computing system. In another example, detecting the issue associated with the second version of the first service may include detecting that a feature associated with the second version of the first service is not working after the upgrade of the services of the distributed computing system. An example feature refers to a unit of functionality of the first service that satisfies a requirement, represents a design decision, and provides a potential configuration option.

At 208, upon detecting an issue associated with the second version of the first service, a rollback operation may be enabled to perform a roll back of the first service in the management plane to the first version while retaining the second version of remaining services. For example, performing the rollback operation may include performing the rollback operation to roll back the first component running in the management plane to the first version while retaining the second version of the second component in the data plane and/or the control plane.

In an example, enabling to perform the rollback operation may include providing, via a user interface of the management plane, a user-selectable option to roll back the first service. Further, in response to a selection of the user-selectable option, the rollback operation may be performed to roll back the first service from the second version to the first version while retaining the second version of the remaining services.

In other examples, example method 200 may include determining a second service that is having a dependency relationship with the second version of the first service. Upon determining the second service, a functionality of the second service that is likely to affect may be determined. Further, a notification may be generated on a user interface to indicate that the functionality of the second service that is likely to affect. In this example, an option may be provided on the user interface to roll back the second service from the second version to the first version.

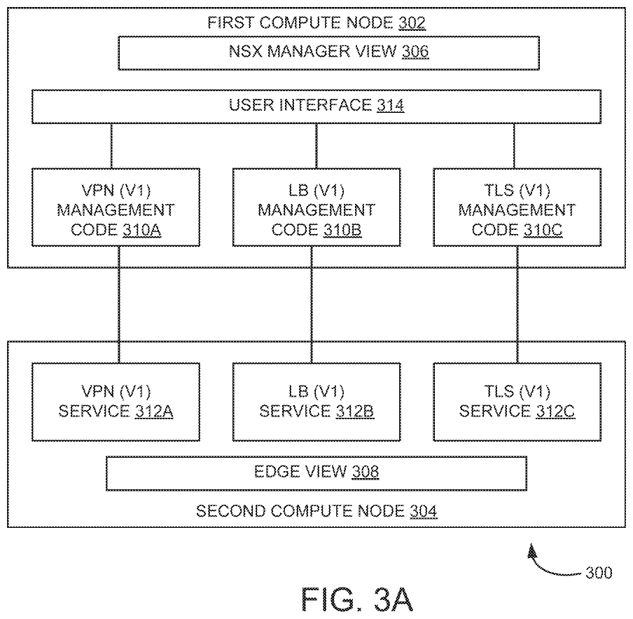

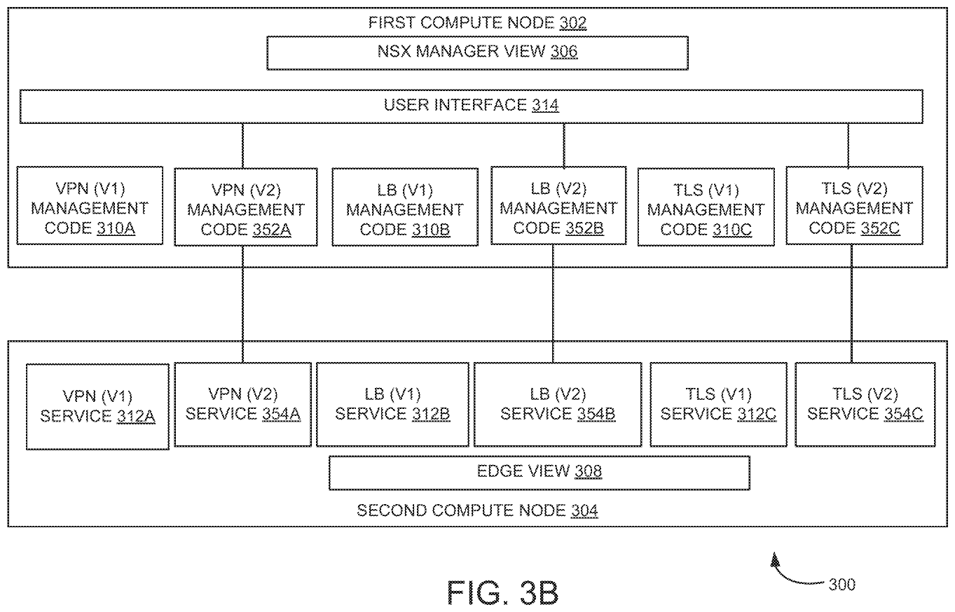

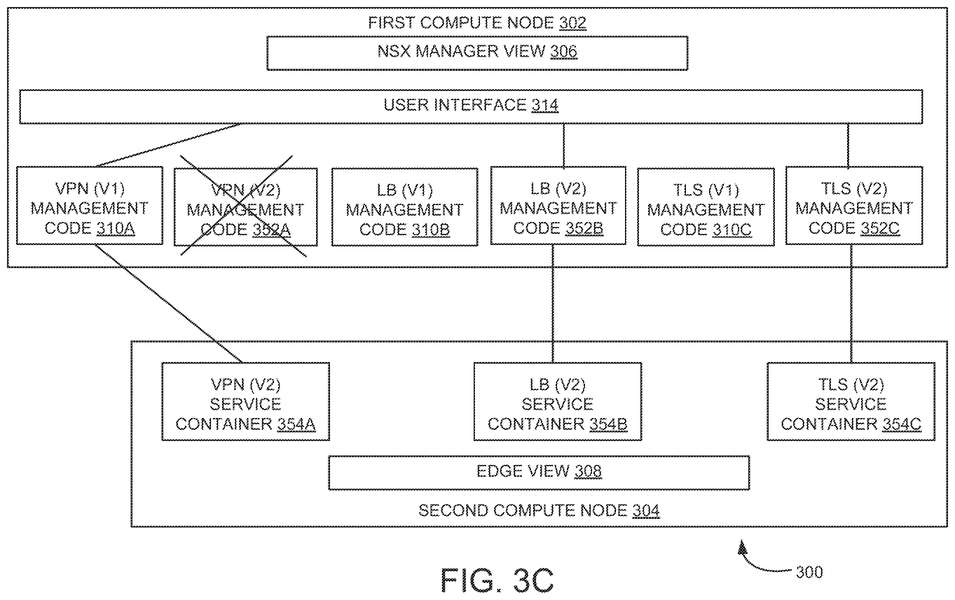

FIG. 3A is a block diagram of an example distributed computing system 300 operating on multiple distributed compute nodes (a first compute node 302 and a second compute node 304) connected over the Internet. For example, distributed computing system 300 includes first compute node 302 (e.g., a first virtual machine) and second compute node 304 (e.g., a second virtual machine) connected to first compute node 302 over the Internet. Example first compute node may be a part of a management plane and second compute node 304 may be a part of a data plane.

For example, the management plane may be built by VMware NSX® manager, which provides a NSX manager view 306 and is the management component offered by Vmware for NSX-T data centers. NSX may be a network virtualization and security platform that enables a virtual cloud network and a software-defined approach to networking. The NSX® manager may provide a user Interface 314 (e.g., a graphical user interface) and REST API for the creation, configuration, and monitoring of NSX-T components such as logical switches, logical routers, and firewalls in the data center. The NSX® manager may be installed as a virtual appliance on any physical host computing system in a VMware vCenter® server environment, which is a server management platform. The NSX-T components may refer to services of distributed computing system 300.

Further, the data plane in NSX-T may include physical host computing systems and edge nodes. The data plane may provide an edge view 308 to configure NSX-T components on hosts and deploying edge nodes to setup logical routing. The NSX-T components of the data plane may refer to services of the distributed computing system. In the example shown in FIG. 3A, the services of the distributed computing system in the management plane and the data/control plane may include, but not limited to, a virtual private network (VPN), a load balancer, and a Transport Layer Security (TLS). The distributed computing system may include services that fall into a) management plane components and b) data plane components and/or control plane components. With edge view 308, enterprises can build, run, manage, connect, and protect their industry specific edge-native applications at the near and far Edge while leveraging the consistent infrastructure and consistent operations across their data centers and cloud.

Consider an initial version of code as V1 before the upgrade as indicated in FIG. 3A. Further, the code corresponding to the services in the management plane and the data plane may be isolated per service. For example, the code corresponding to VPN V1 310A, load balancer (LB) V1 310B, and TLS V1 310C in the management plane may be isolated as shown in FIG. 3A. Similarly, the code corresponding to VPN V1 312A, LB V1 312B, and TLS V1 312C in the data plane may be isolated per service. In an example, the code can be isolated using a container, a namespace, or a separate jar file per service.

FIG. 3B is a block diagram of example distributed computing system 300 of FIG. 3A, depicting upgraded services of distributed computing system 300. For example, upon receiving a request to upgrade distributed computing system 300, the services in distributed computing system 300 are upgraded. Consider that the upgraded version of the code as V2 after the upgrade as indicated in FIG. 3B. As shown in FIG. 3B, VPN V1 310A is upgraded to VPN V2 352A, LB V1 310B is upgraded to LB V2 352B, and TLC V1 310C is upgraded to TLC V2 352C. Similarly, the services in the data plane may be upgraded to next version V2 (e.g., VPN V1 312A to VPN V2 354A, LB V1 312B to LB V2 354B, and TLS V1 312C to TLS V2 354C). Thus, distributed computing system 300 is upgraded to the next version V2. Further, post upgrade, distributed computing system 300 may include version V2 of each service and version V1 of each service may be retained for roll back purpose as shown in FIG. 3B.

FIG. 3C is a block diagram of example distributed computing system 300 of FIG. 3B, depicting per service version roll back. For example, upon upgrading distributed computing system 300 as shown in FIG. 3B, consider that an issue is detected in VPN V2 352A of the management plane. Hence, the user may not be able to configure VPN. Further, other upgraded services in distributed computing system 300 may be working as expected. In this example, only VPN version V2 management code in the management plane may be rolled back to VPN version V1 as shown in FIG. 3C. In this example, the data plane may be backward compatible with the management plane such that operations of the VPN version V1 of the VPN service in the management plane can be compatible with operations of the VPN version V2 of the VPN service in the data plane.

FIG. 4 is a user interface (e.g., user interface 314 of FIG. 3A) of a management plane, depicting a user-selectable option to roll back a service. In an example, upon completing the upgrade of a distributed computing system, a user-selectable option (e.g., 402) may be provided on user interface 314 of the management plane to roll back a service. As shown in FIG. 4, different services (e.g., VPN, LB, TLS, and IDPS) of the distributed computing system may be displayed on user interface 314 for the user to select for the roll back (e.g., using a rollback option 404). Further, upon a user selection of the user-selectable option (e.g., a selection of a VPN as shown in FIG. 4), the rollback operation may be performed to roll back the service (e.g., the VPN) from the second version to the initial or first version while retaining the second/upgraded version of the remaining services (LB, TLS, and IDPS). In some examples, a separate roll back service may be included in the NSX manager, which may be executed to take care of the roll back process.

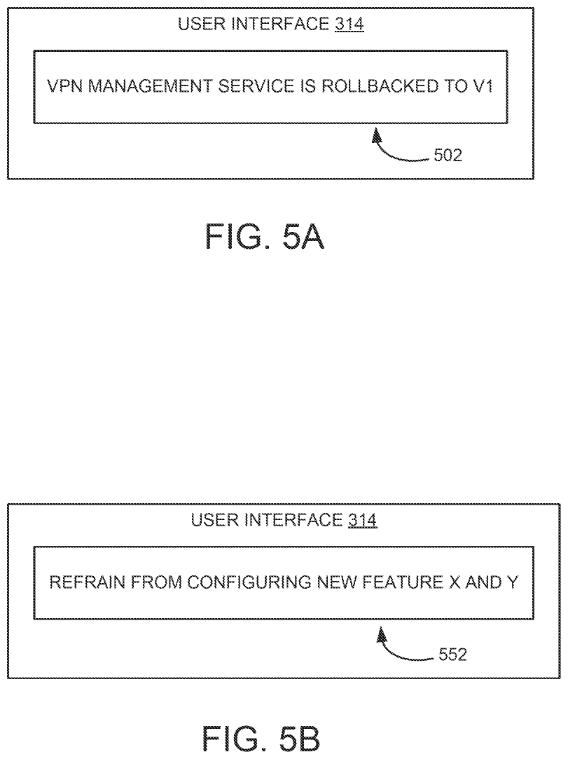

FIG. 5A is an example user interface (e.g., user interface 314 of FIG. 3A) of the management plane depicting an example message 502 indicating that the

VPN service is rolled back to the first version. Consider a scenario where there is no new feature in the upgraded version V2 of the VPN service. When the second version V2 includes existing feature enhancements or optimization without any new features, all the components of the user interface, the management plane, and the data path may work together. In this case, upon roll back of the service (e.g., the VPN), message 502 may be displayed on user interface 314 indicating “VPN management service is rolled back to V1”. Further, other services will work as expected and there will be no impact. Furthermore, the user can wait till the issue gets resolved without any impact in customer's production environment.

FIG. 5B is another example user interface 314 of the management plane depicting an example message 552 indicating an unavailability of a new feature of upgraded version V2. Consider a scenario where there is a new feature in the upgraded version V2 of the VPN service. In this example, upon roll back of the service (e.g., the VPN), a warning message 552 may be displayed on user interface 314 for the VPN indicating “refrain from configuring new features X and Y”. Thus, the user interface design should be considered in a way that will honor the management plane roll back per service. In other words, the user interface may work with the initial version V1 of the VPN service code in the management plane. In some example, even if the user is not able to configure the VPN from user interface 314, the API can still work. Further, the data path may continue to work. Thus, there will be no impact in the customer's production environment. Also, all other services in the management plane and the data plane may work as expected and there will be no impact. Furthermore, the user can wait till the issue gets resolved without any impact in customer's production environment.

Further, examples described in FIGS. 3A, 3B, 3C, 4, 5A, and 5B may be considered as a design model of a product and may not be limited to the NSX as some products can have a management plane and a data path (i.e., data plane), and no user interface. Also, some products can offer various web applications but no data path. The roll back of the web application can also be implemented using the examples described herein. In other examples, some products can have a management plane, a data plane, and a control plane. For the edge data path, a backward compatibility with respect to the management plane may be supported, i.e., the edge data path can be on version V2 and the management plane can be on version V1.

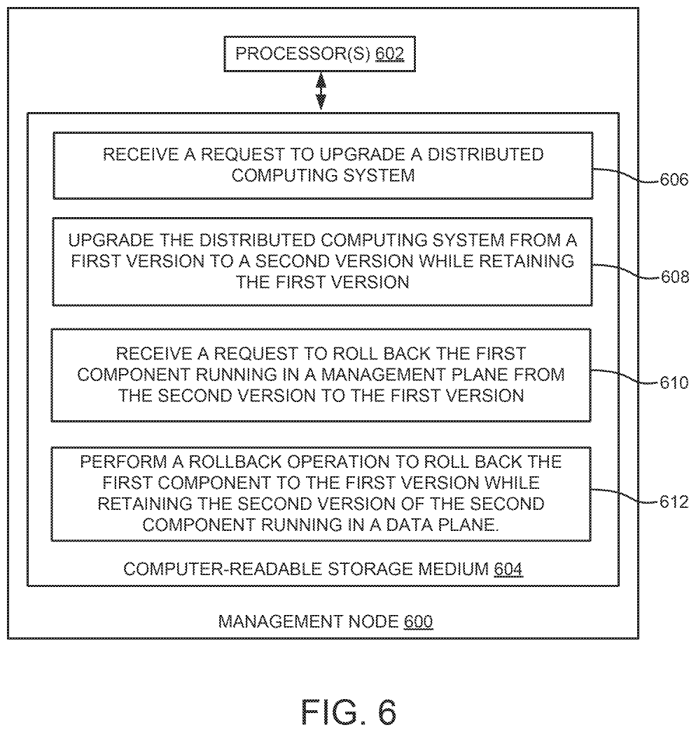

FIG. 6 is a block diagram of an example management node 600 including non-transitory computer-readable storage medium 604 storing instructions to perform version roll back of individual services in a distributed computing system. Management node 600 may include a processor 602 and computer-readable storage medium 604 communicatively coupled through a system bus. Processor 602 may be any type of central processing unit (CPU), microprocessor, or processing logic that interprets and executes computer-readable instructions stored in computer-readable storage medium 604. Computer-readable storage medium 604 may be a random-access memory (RAM) or another type of dynamic storage device that may store information and computer-readable instructions that may be executed by processor 602. For example, computer-readable storage medium 604 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 604 may be a non-transitory computer-readable medium. In an example, computer-readable storage medium 604 may be remote but accessible to management node 600.

Computer-readable storage medium 604 may store instructions 606, 608, 610, and 612. Instructions 606 may be executed by processor 602 to receive a request to upgrade the distributed computing system. In an example, the distributed computing system may include a microservices architecture. A microservice architecture is a method of developing software applications as a suite of independently deployable, small, modular services in which each microservice runs a unique process and communicates through a well-defined, lightweight mechanism to serve a business goal. These microservices can be deployed, modified, and then redeployed independently without compromising the integrity of an application. In a microservice architecture, when developing an application program, the application program is divided into a plurality of small services, and the application program is constructed by merging the divided small services. That is, in the microservice architecture, one application service is created by specializing each service for each module and connecting and integrating the respective modules using interfaces.

For example, the distributed computing system may include a first service (e.g., a VPN) having a first component running in a management plane and a second component running in a data plane. The first component may run in a first isolated virtual computing instance of a first compute node in the management plane such that the first component executes in isolation from other services running on the first compute node. Further, the second component may run in a second isolated virtual computing instance of a second compute node in the data plane such that the second component executes in isolation from other services running in the second compute node. In an example, the data plane may be backward compatible with the management plane such that operations of the first version of the first component in the management plane can be compatible with operations of the second version of the second component in the data plane.

Instructions 608 may be executed by processor 602 to upgrade the distributed computing system from a first version to a second version while retaining the first version. Upon upgrading the distributed computing system, instructions 610 may be executed by processor 602 to receive a request to roll back the first component running in the management plane from the second version to the first version. In an example, instructions 610 to receive the request to roll back the first component may include instructions to provide, via a user interface of the management plane, a user-selectable option to roll back the first component and receive the request to roll back the first component via the user-selectable option.

In response to receiving the request, instructions 612 may be executed by processor 602 to perform a rollback operation to roll back the first component to the first version while retaining the second version of the second component running in the data plane. Further, computer-readable storage medium 604 may store instructions to determine a second service of the distributed computing system that is having a dependency relationship with the second version of the first service. Furthermore, computer-readable storage medium 604 may store instructions to determine a functionality of the second service that is likely to affect. Further, computer-readable storage medium 604 may store instructions to generate a notification on a user interface. For example, the notification may indicate the functionality of the second service that is likely to affect.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A system comprising:
a first compute node comprising:
a first isolated virtual computing instance executing a first version of a first service of a distributed computing system; and
a second isolated virtual computing instance executing a first version of a second service of the distributed computing system; and
a management node comprising:
a processor; and
a memory coupled to the processor, wherein the memory comprises a version rollback module to:
receive a request to upgrade the distributed computing system;
upgrade the distributed computing system including the first service and the second service to a second version while retaining the first version of the first service and the second service;
upon upgrading the distributed computing system, detect an issue associated with the second version of the first service; and
upon detecting the issue, perform a rollback operation to roll back the first service to the first version while retaining second version of the second service.

2. The system of claim 1, further comprising:
a second compute node comprising:
a third isolated virtual computing instance executing a first version of a third service of the distributed computing system, wherein the version rollback module is to upgrade the distributed computing system including the first service, the second service, and the third service to a second version.

3. The system of claim 2, wherein the first compute node is part of a management plane and the second compute node is part of a data plane or a control plane.

4. The system of claim 1, wherein the version rollback module is to:
during the upgrade of the distributed computing system, detect an error or failure associated with the upgrade of the first service; and
in response to detecting the error or failure associated with the upgrade of the first service, perform the rollback operation to roll back the first service to the first version while retaining the second version of the second service.

5. The system of claim 1, wherein the version rollback module is to:
upon completing the upgrade of the distributed computing system, provide a user-selectable option to roll back the first service in a user interface of a management plane; and
upon a user selection of the user-selectable option, perform the rollback operation to roll back the first service from the second version to the first version while retaining the second version of the second service.

6. The system of claim 1, wherein the version rollback module is to:
upon completing the upgrade of the distributed computing system, provide a user-selectable option in a user interface of a management plane to enable a user to navigate through a roll back process of the first service.

7. The system of claim 1, wherein the version rollback module is to:
upon rolling back the first service to the first version and when the second version of the first service does not include a new feature, display a notification on a user interface of the first service indicating that the first service is rolled back to the first version.

8. The system of claim 1, wherein the version rollback module is to:
upon rolling back the first service to the first version and when the second version of the first service includes a new feature, display a notification on a user interface of the first service indicating an unavailability of the new feature.

9. The system of claim 1, wherein the version rollback module is to:
determine a dependent service of the distributed computing system that is having a dependency relationship with the second version of the first service;
determine a functionality of the dependent service that is likely to affect; and
generate a notification on a user interface, wherein the notification is to indicate the functionality of the dependent service that is likely to affect.

10. A non-transitory computer readable storage medium having instructions executable by a processor of a management node to:
receive a request to upgrade a distributed computing system comprising a microservices architecture, wherein the distributed computing system comprises a first service having a first component running in a management plane and a second component running in a data plane;
upgrade the distributed computing system from a first version to a second version while retaining the first version;
upon upgrading the distributed computing system, receive a request to roll back the first component running in the management plane from the second version to the first version; and
in response to receiving the request, perform a rollback operation to roll back the first component to the first version while retaining the second version of the second component running in the data plane.

11. The non-transitory computer readable storage medium of claim 10, wherein the first component is to run in a first isolated virtual computing instance of a first compute node in the management plane such that the first component executes in isolation from other services running on the first compute node, and wherein the second component is to run in a second isolated virtual computing instance of a second compute node in the data plane such that the second component executes in isolation from other services running in the second compute node.

12. The non-transitory computer readable storage medium of claim 10, wherein instructions to receive the request to roll back the first component comprise instructions to:
provide, via a user interface of the management plane, a user-selectable option to roll back the first component; and
receive the request to roll back the first component via the user-selectable option.

13. The non-transitory computer readable storage medium of claim 10, wherein the data plane is backward compatible with the management plane such that operations of the first version of the first component in the management plane can be compatible with operations of the second version of the second component in the data plane.

14. The non-transitory computer readable storage medium of claim 10, further comprising instructions to:
determine a second service of the distributed computing system that is having a dependency relationship with the second version of the first service;
determine a functionality of the second service that is likely to affect; and
generate a notification on a user interface, wherein the notification is to indicate the functionality of the second service that is likely to affect.

15. A computer-implemented method comprising:
receiving a request to upgrade a distributed computing system, the distributed computing system comprising multiple services running on respective isolated virtual computing instances in a network virtualization platform, the network virtualization platform comprising a management plane and at least one of a data plane and a control plane;
upgrading the services of the distributed computing system from a first version to a second version while retaining the first version associated with the services;
upon upgrading the distributed computing system, detecting an issue associated with the second version of a first service of the services in the management plane; and
upon detecting an issue associated with the second version of the first service, enabling to perform a rollback operation to roll back the first service in the management plane to the first version while retaining the second version of remaining services.

16. The method of claim 15, wherein enabling to perform the rollback operation comprises:
providing, via a user interface of the management plane, a user-selectable option to roll back the first service; and
in response to a selection of the user-selectable option, performing the rollback operation to roll back the first service from the second version to the first version while retaining the second version of the remaining services.

17. The method of claim 15, further comprising:
determining a second service that is having a dependency relationship with the second version of the first service;
determining a functionality of the second service that is likely to affect; and
generating a notification on a user interface, wherein the notification is to indicate the functionality of the second service that is likely to affect.

18. The method of claim 17, further comprising:
providing an option, on the user interface, to roll back the second service from the second version to the first version.

19. The method of claim 15, wherein detecting the issue associated with the second version of the first service comprises one of:
during the upgrading of the services of the distributed computing system, detecting an error or failure associated with the upgrade of the first service; and
after the upgrade of the services of the distributed computing system, detecting that a feature associated with the second version of the first service is not working.

20. The method of claim 15, wherein the first service comprises a first component running in the management plane and a second component running in the data plane and/or the control plane, and wherein performing the rollback operation comprises:
performing the rollback operation to roll back the first component running in the management plane to the first version while retaining the second version of the second component in the data plane and/or the control plane.
